(19) United States
(12) Patent Application Publication
(10) Pub. No.: US 2015/0024686 A1
(43) Pub. Date: Jan. 22, 2015

(54) SECURE SIMPLE PAIRING THROUGH EMBEDDED VEHICLE NETWORK ACCESS DEVICE

(71) Applicant: GM Global Technology Operations LLC, Detroit, MI (US)

(72) Inventor: Robert A. Hrabak, West Bloomfield, MI (US)

(21) Appl. No.: 13/943,128

(22) Filed: Jul. 16, 2013

(51) Int. Cl. H04W 4/00

(52) U.S. Cl. CPC H04W 4/008
USPC 455/41.2

(57) ABSTRACT

Secure simple pairing is provided by receiving, from a mobile communications device, vehicle information and an identifier of the mobile communications device, identifying a vehicle from the vehicle information, and sending the vehicle information and the identifier of the mobile communications device to the vehicle. The vehicle initiates a communication with the mobile communications device using the vehicle information and the identifier of the mobile communications device.

### FIELD OF THE INVENTION

The subject invention relates to securing wireless communications between a mobile communications device and a vehicle and, more particularly, to secure simple pairing of a mobile communications device with a vehicle to authenticate wireless communications between the mobile communications device and the vehicle.

### BACKGROUND

Mobile communications devices, such as smart phones, are advanced devices that offer much more functionality than the telephony features provided by their predecessors. Currently, these advanced mobile devices provide the ability to run complex applications based on a particular platform. There has been an increasing growth in demand for smart phones due to their advanced computer processing capabilities.

With the prevalence of smart phones, many people who spend a lot of time in their vehicles expect their smart phones or other mobile communications devices to be able to communicate with the vehicle. For example, it is desirable for phone calls to be placed or received in a hands-free fashion through the vehicle's audio system when a phone is inside the vehicle. This type of integration requires secure, reliable communications between the phone, or other mobile communications device, and the vehicle. While some vehicles now offer wireless communications between devices and the vehicle, the associated set-up processes can be cumbersome.

It would be desirable to enable secure wireless communications between a mobile communications device and a vehicle, by using an existing trusted out-of-band source to establish a shared secret.

### SUMMARY OF THE INVENTION

In one exemplary embodiment of the invention, a system is provided. The system includes a computer processor and logic executable by the computer processor. The logic is configured to implement a method. The method includes receiving, from a mobile communications device, vehicle information and an identifier of the mobile communications device, identifying a vehicle from the vehicle information, and sending the vehicle information and the identifier of the mobile communications device to the vehicle. The vehicle initiates a communication with the mobile communications device using the vehicle information and the identifier of the mobile communications device.

In another exemplary embodiment of the invention, a method is provided. The method includes receiving, from a mobile communications device, vehicle information and an identifier of the mobile communications device, identifying a vehicle from the vehicle information, and sending the vehicle information and the identifier of the mobile communications device to the vehicle. The vehicle initiates a communication with the mobile communications device using the vehicle information and the identifier of the mobile communications device.

In yet another exemplary embodiment of the invention, a computer program product is provided. The computer program product comprises a computer-readable storage medium having instructions embodied thereon, which when executed by the computer processor causes the computer processor to implement a method. The method includes receiving, from a mobile communications device, vehicle information and an identifier of the mobile communications device, identifying a vehicle from the vehicle information, and sending the vehicle information and the identifier of the mobile communications device to the vehicle. The vehicle initiates a communication with the mobile communications device using the vehicle information and the identifier of the mobile communications device.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a system upon which secured wireless pairing and communications between a mobile communications device and a vehicle may be implemented in accordance with an exemplary embodiment;

FIG. 2 is depicts a network access device for implementing the secured wireless pairing and communications in accordance with an exemplary embodiment; and

FIGS. 3A-3D are flow diagrams describing processes for implementing secured wireless pairing and communications between a mobile communications device and a vehicle in accordance with an exemplary embodiment.

### DESCRIPTION OF THE EMBODIMENTS

The following description is merely exemplary in nature and is not intended to limit the present disclosure, its application or uses.

In accordance with an exemplary embodiment of the invention, secure simple pairing and wireless communications between a mobile communications device and a vehicle are provided. The exemplary processes establish secure wireless communications between the mobile communications device and a network access device embedded in the vehicle. A telematics system (such as OnStar®) of the vehicle is used to bootstrap the trust between the mobile communications device and the vehicle.

A pairing process is performed between the mobile communications device and the network access device of the vehicle using information gained by the mobile communications device about the vehicle. Once the pairing process is completed, the network access device of the vehicle initiates a connection with the mobile communications device over a short-range wireless network, and a user of the mobile communications device may implement vehicle functions, such as remote starting of the vehicle, through the mobile communications device in lieu of a key or a fob. These and other features of the exemplary processes will now be described.

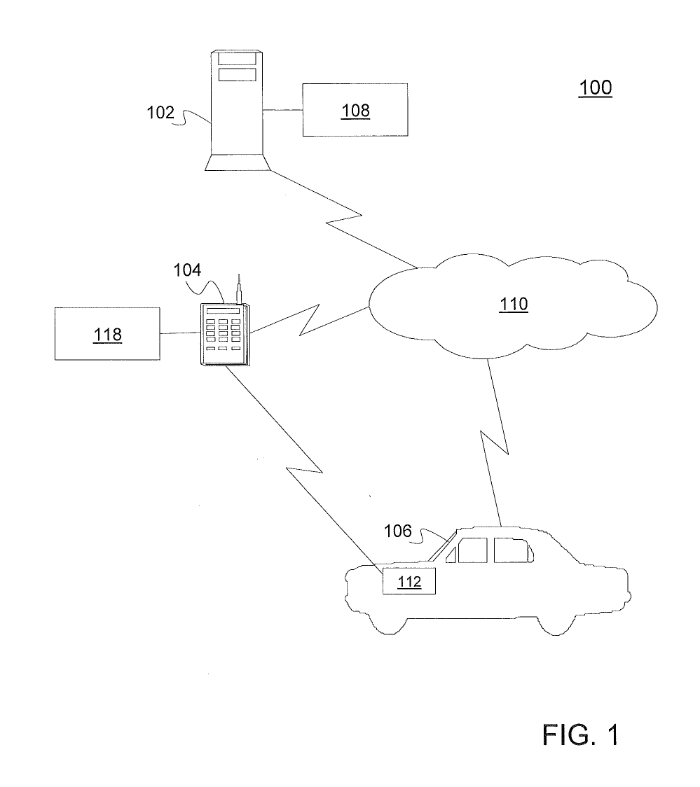

Turning now to FIG. 1, a system 100 upon which secure simple pairing and wireless communications between a mobile communications device and a vehicle may be implemented will now be described in an exemplary embodiment.

The system 100 includes a telematics service provider computer 102, a vehicle 106, and a mobile communications device 104 of a user of the vehicle 106 (e.g., an owner or operator of the vehicle 106). The vehicle 106 supports wireless connectivity of onboard mobile devices through an embedded network access device 112. In an embodiment, Bluetooth® is used for such wireless connectivity. Bluetooth pairing, or establishing secure wireless communications, can be accomplished via Secure Simple Pairing (SSP).

The exemplary processes authenticate two communicating devices using a trusted third-party or “out-of-band” medium. In particular, the vehicle 106 hosts a Bluetooth network which the mobile communications device 104 desires to join. The mobile communications device 104 is presumed to be within, or in close proximity to, the vehicle 106. The vehicle 106 has access to the telematics service provider computer 102, such as OnStar, via a cellular service provider, which may be one of networks 110. The mobile communications device 104 may receive phone and data services through a cellular service provider, which may be the same service provider as the cellular service provider of the vehicle 106 or may be different. The cellular service provider(s) communicate with the Internet (e.g., one of networks 110), from which the telematics service provider computer 102 may be reached. With this architecture, the wireless communication trust between the vehicle 106 and the mobile communications device 104 can be bootstrapped, or self-enabled, by using the telematics service provider computer 102 as a trusted out-of-band medium.

In the system 100, it is assumed that both of the cellular communication Link—from the vehicle 106 to the cellular service provider (e.g., one of networks 110), and from the mobile communications device 104 to the cellular service provider (e.g., one of the networks 110)—are secure. It is also assumed that the communication links from the cellular service provider to the Internet, and from the telematics service provider computer 102 to the Internet, are secure.

The telematics service provider computer 102 may be implemented as a high-speed computer processing device (e.g., a mainframe computer) capable of handling a high volume of activities conducted between the computer 102 and the network entities (e.g., mobile communications device 104 and network access device 112 in vehicle 106 shown in FIG. 1). The telematics service provider computer 102 may operate as a web server including a web site for generating subscription accounts for vehicle manufacturers and/or dealerships, as well as for providing access to secure pairing information to users or consumers of telematics services. In an embodiment, the telematics service provider computer 102 implements logic 108 for communicating with both the mobile communications device 104 and the vehicle 106 (e.g., receiving vehicle information from the mobile communications device 104 and forwarding the information on to the vehicle 106. In addition, the logic 108 is configured to generate and transmit authentication values to the mobile communications device, as will be described further herein.

The mobile communications device 104 may be a cellular telephone with enhanced functionality (e.g., smart phone). The mobile communications device 104 includes memory and communication components. The memory may store and execute one or more applications typically associated with a mobile communications device (e.g., text messaging application, web browser, contacts/address folder, voicemail, etc.). The communication components enable the mobile communications device 104 to communicate over one or more networks, such as networks 110. The mobile communications device 104 is configured with various communication protocols for enabling the communications through its communication components. For example, the protocols may include Wi-fi, Bluetooth Smart® low energy (“BLE”) protocol, and cellular communication protocols.

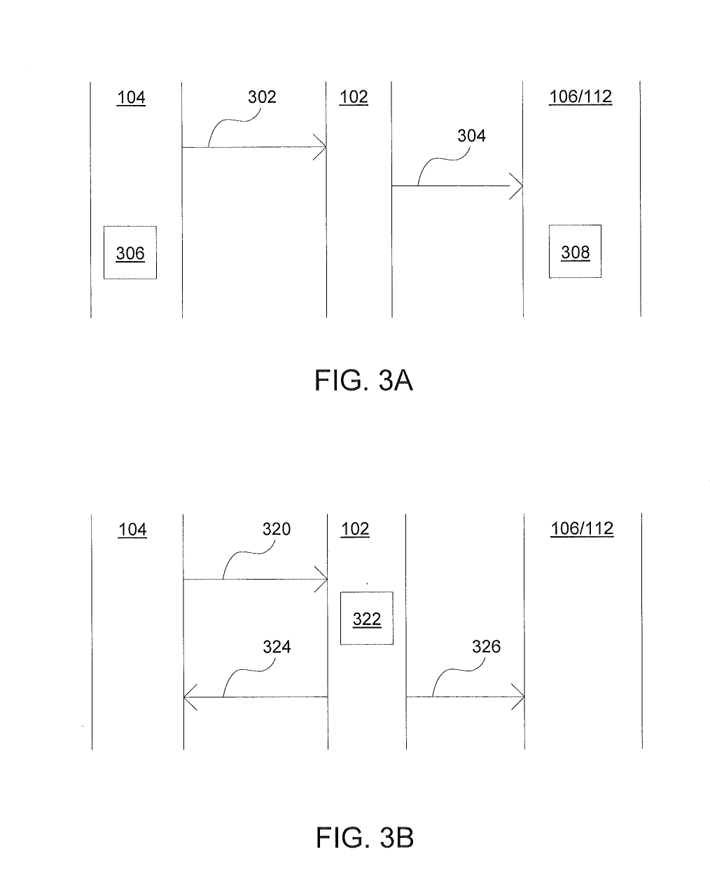

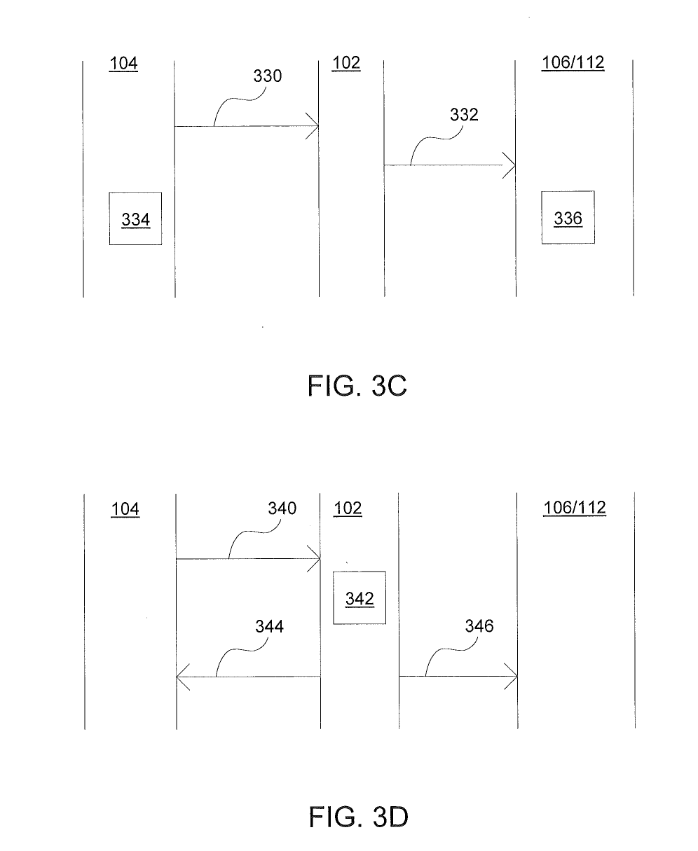

As indicated above, the mobile communications device 104 implements various applications, such as a web browser, text messaging application, etc. In an embodiment, the mobile communications device 104 also executes an application or logic 118 for initiating a pairing feature of the secure pairing described herein. The pairing feature is described further in FIG. 3. Logic 118 may include a user interface, which may be provided to the user via a display panel of the mobile communications device 104. The pairing feature may include an encryption algorithm for facilitating a secured pairing between the mobile communications device 104 and the network access device 112 of the vehicle 106. In one embodiment, the mobile communications device 104 includes a scanner (not shown) configured to scan, e.g., universal product codes (UPCs) and/or quick response (QR) codes, as will be described further herein.

The vehicle 106 may include various vehicle components, such as a passive-entry passive-start (PEPS) module and related circuitry and antennae, as well as a central controller that manages the communications across the vehicle's network (e.g., a local area network). These components are well understood by those skilled in the art and will not be further discussed.

The networks 110 may include a combination of networks (e.g., cellular, satellite, terrestrial), and may include local area networks, wide area networks, and the Internet).

As indicated above, the exemplary secure simple pairing and wireless communications processes provide additional functionality to the mobile communications device 104, such as enabling the remote start of the vehicle 106 in lieu of a key or a fob. A pairing process is performed between the mobile communications device 104 and the network access device 112 of the vehicle 106 using information gained by the mobile communications device 104 about the vehicle 106. Once the pairing process has been successfully completed, the network access device 112 initiates a connection with the mobile communications device 104 over a short-range wireless network, such as Bluetooth, and the mobile communications device 104 can initiate a vehicle start up absent the need for a key or key fob.

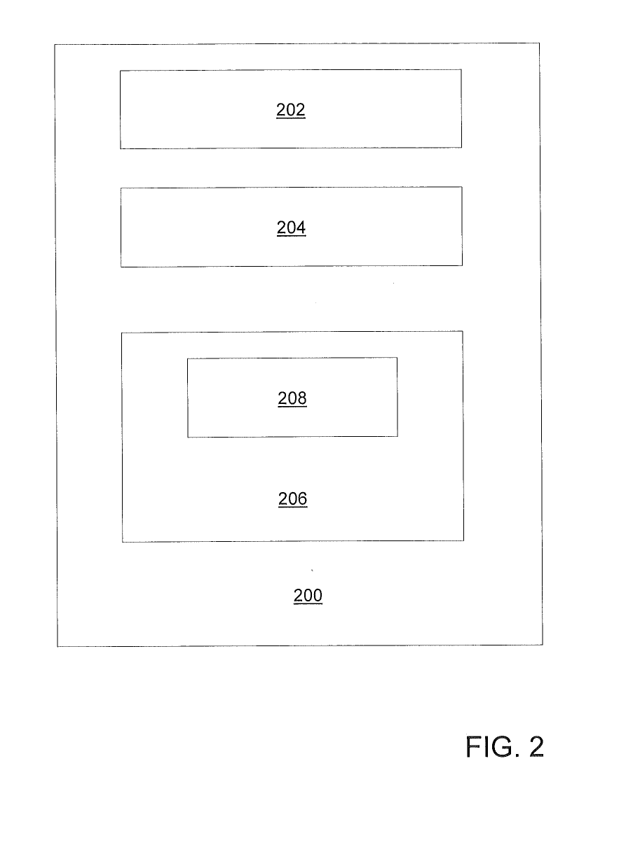

Turning now to FIG. 2, a network access device 200 for implementing secure simple pairing and wireless communications will now be described in an exemplary embodiment. The network access device 200 corresponds to the network access device 112 of FIG. 1.

The network access device 112 may include telematics system components embedded in the vehicle 106. The network access device 112 includes communications components 202, such as an antenna, a computer processor 204, memory 206, and logic 208 stored in the memory 206 and executable by the computer processor 204. The communications components 202 are configured to communicate over a short-range wireless network using radio frequency signaling. The communications components may be Bluetooth-enabled components.

The logic 208 is configured to process data received from the mobile communications device 104 and the telematics service provider computer 102, as will be described further herein.

Turning now to FIGS. 3A-3D, flow diagrams describing processes for secure pairing and wireless communications in accordance with an exemplary embodiment will now be described. For purposes of illustration, it is assumed that the user of the mobile communications device 104 has purchased the vehicle 106 and is ready to pair his/her mobile communications device 104 to the vehicle 106. In one embodiment, vehicle information used in the pairing process is provided to the user, e.g., at the time of vehicle purchase. The vehicle information may include one or more of a vehicle identification number (VIN), a mobile equipment identifier of the network access device 112, a phone number of the network access device 112, and a telematics service account identifier associated with the vehicle 106.

In one embodiment, the vehicle information may be relayed to the mobile communications device 104 via encoded information (e.g., UPC or QR code) on a tag or paper associated with the vehicle 106. In another embodiment, the vehicle information may be transmitted to the user's mobile communications device 104, or to the telematics service provider computer 102 servicing the vehicle 106, over the networks 110.

In FIG. 3A, the mobile communications device 104 acquires the vehicle information and sends (302) the information to the telematics service provider computer 102. The telematics service provider 102 identifies the vehicle 106 from the information and forwards (304) the information on to the vehicle 106. At this point, both the mobile communications device 104 and the vehicle 106 have the necessary information to establish (306 and 308, respectively) an authentication value (e g , link key) for use in pairing the mobile communications device 104 to the vehicle 106.

In FIG. 3B, the mobile communications device 104 acquires the vehicle information and sends (320) the information as a payload (e.g., a cellular packet) to the telematics service provider computer 102. The telematics service provider 102 identifies the vehicle 106 from the information, generates (322) an authentication value (e.g., link key), and sends (324) the authentication value to the mobile communications device 104 and also sends (326) the authentication value to the vehicle 106.

In FIG. 3C, the mobile communications device 104 acquires the vehicle information and sends (330) the information to the telematics service provider computer 102 as a text message. The telematics service provider 102 identifies the vehicle 106 from the information and forwards (332) the text message on to the vehicle 106. At this point, both the mobile communications device 104 and the vehicle 106 have the necessary information to establish (334 and 336, respectively) an authentication value (e.g., link key) for use in pairing the mobile communications device 104 to the vehicle 106.

In FIG. 3D, the mobile communications device 104 acquires the vehicle information and sends (340) the information as a text message to the telematics service provider computer 102. The telematics service provider 102 identifies the vehicle 106 from the information, generates (342) an authentication value (e.g., link key), and sends (344) the authentication value to the mobile communications device 104 and also sends (346) the authentication value to the vehicle 106.

In an embodiment, the logic 118 of the mobile communications device 104 creates seed information for generating the authentication value. The logic 118 may encrypts a unique identifier of the mobile communications device 104 before sending the vehicle information and the unique identifier to the telematics service provider computer 102. In an embodiment, the unique identifier is a Bluetooth network address of the mobile communications device 104. The seed information may also be encrypted.

Once the authentication value is received by the vehicle 106, or alternatively, once the value has been generated by the vehicle 106, the network access device 112 stores the authentication value in the memory 206.

The network access device 112 initiates a connection with the mobile communications device 104 over a short-range wireless communications network. Once this pairing process has completed, the mobile communications device 104 may initiate various functions for implementation by the vehicle, e.g., remote start when the devices are in communicative range of one another.

Technical effects include secure simple pairing and wireless communications between a mobile communications device and a vehicle network access device using a telematics service provider system. A pairing process is performed between the mobile communications device and a network access device of the vehicle using information gained by the mobile communications device about the vehicle. Once the pairing process has been successfully completed, the network access device initiates a connection with the mobile communications device over a short-range wireless network, and the mobile communications device can initiate vehicle start up absent the need for a key or key fob.

As described above, the invention may be embodied in the form of computer implemented processes and apparatuses for practicing those processes. Embodiments of the invention may also be embodied in the form of computer program code containing instructions embodied in tangible media, such as floppy diskettes, CD-ROMs, hard drives, or any other computer readable storage medium, wherein, when the computer program code is loaded into and executed by a computer, the computer becomes an apparatus for practicing the invention. An embodiment of the invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the present application.

What is claimed is:

1. A system, comprising:
a computer processor; and
logic executable by the computer processor, the logic configured to implement a method, the method comprising:
receiving, from a mobile communications device, vehicle information and an identifier of the mobile communications device;
identifying a vehicle from the vehicle information; and
sending the vehicle information and the identifier of the mobile communications device to the vehicle, wherein the vehicle initiates a communication with the mobile communications device using the vehicle information and the identifier of the mobile communications device.

2. The system of claim 1, wherein the vehicle information is received from the mobile communications device over a first network, and the vehicle information and the identifier of the mobile communications device are sent to the vehicle over a second network.

3. The system of claim 1, wherein the vehicle information includes instructions to generate an authentication value.

4. The system of claim 1, wherein the authentication value is a link key.

5. The system of claim 1, wherein the vehicle information includes at least one of:
a vehicle identification number;
a mobile equipment identifier of a network access device in the vehicle;
a phone number of the network access device; and
a telematics service account identifier, wherein the network access device is a telematics system.

6. The system of claim 1, wherein the mobile communications device is a smart phone.

7. The system of claim 1, wherein the authentication value is used to initiate a pairing process between the mobile communications device and the vehicle.

8. The system of claim 1, wherein the vehicle information from the mobile communications device is received as a cellular packet payload.

9. The system of claim 1, wherein the vehicle information from the mobile communications device is received as a text message.

10. The system of claim 1, wherein the vehicle information sent to the vehicle is transmitted as a text message.

11. A method, comprising:
receiving, at a computer processor from a mobile communications device, vehicle information and an identifier of the mobile communications device;
identifying a vehicle from the vehicle information; and
sending the vehicle information and the identifier of the mobile communications device to the vehicle, wherein the vehicle initiates a communication with the mobile communications device using the vehicle information and the identifier of the mobile communications device.

12. The method of claim 11, wherein the vehicle information is received from the mobile communications device over a first network, and the vehicle information and the identifier of the mobile communications device are sent to the vehicle over a second network.

13. The method of claim 11, wherein the vehicle information includes instructions to generate an authentication value.

14. The method of claim 11, wherein the authentication value is a link key.

15. The method of claim 11, wherein the vehicle information includes at least one of:
a vehicle identification number;
a mobile equipment identifier of a network access device in the vehicle;
a phone number of the network access device; and
a telematics service account identifier, wherein the network access device is a telematics system.

16. The method of claim 11, wherein the mobile communications device is a smart phone.

17. The method of claim 11, wherein the authentication value is used to initiate a pairing process between the mobile communications device and the vehicle.

18. The method of claim 11, wherein the vehicle information from the mobile communications device is received as a cellular packet payload.

19. The method of claim 11, wherein the vehicle information from the mobile communications device is received as a text message; and
wherein the vehicle information sent to the vehicle is transmitted as a text message.

20. A computer program product comprising a computer-readable storage medium having program code embodied thereon, which when executed by a computer processor, causes the computer processor to implement a method, the method comprising:
receiving, from a mobile communications device, vehicle information and an identifier of the mobile communications device;
identifying a vehicle from the vehicle information; and
sending the vehicle information and the identifier of the mobile communications device to the vehicle, wherein the vehicle initiates a communication with the mobile communications device using the vehicle information and the identifier of the mobile communications device.
